(19) United States
(12) Patent Application Publication
(10) Pub. No.: US 2007/0191011 A1
(43) Pub. Date: Aug. 16, 2007

(54) Caller line identification in mobile number portability

(76) Inventor: John Yue Jun Jiang, Danville, CA (US)

Correspondence Address: ARENT FOX PLLC, 1050 CONNECTICUT AVENUE, N.W., SUITE 400, WASHINGTON, DC, 20036, US

(21) Appl. No.: 11/700,256

(22) Filed: Jan. 31, 2007

Related U.S. Application Data
(60) Provisional application No. 60/764,032, filed on Jan. 31, 2006.

(51) Int. Cl. H04Q 7/20

(52) U.S. Cl. 455/436

(57) ABSTRACT

A system, method, and computer product are provided for facilitating mobile number portability. The method includes receiving a registration message at a signaling gateway (SG) for an International Mobile Subscriber Identity (IMSI) associated with a subscriber ported-in in a first network. The method further includes replacing at the SG, a first Mobile Station International Subscriber Directory Number (MSISDN) with an original MSISDN in a registration response message sent upon receipt of the registration message.

### RELATED APPLICATIONS

This application is a continuation-in-part of and claims the benefit of U.S. Provisional Patent Application No. 60/764,032, entitled “SIMM Variations,” filed Jan. 31, 2006, which is incorporated herein by this reference in its entirety.

### FIELD OF THE INVENTION

The present invention generally relates to roaming users in mobile networks. More specifically, the invention relates to mobile number portability for the roaming users in mobile networks.

### BACKGROUND OF THE INVENTION

More and more subscribers are using mobile phone services. They may wish to change from a network operator in one country to another network operator in the same country without changing their mobile number (MSISDN). Hence, Mobile Number Portability (MNP) use is gaining popularity. MNP use allows a subscriber of one network operator to change to another network operator, without changing his mobile number. A subscriber using MNP may port-out his original number to an operator servicing a first network. The subscriber may also be roaming in a second network, when the subscriber originally belonged to another network operator servicing a third network. Hence, the subscriber's original number is a ported-in number from the perspective of the first network, while the original number is ported-out from the perspective of the third network.

One or more available techniques implement MNP by using call forwarding. In an existing call forwarding approach, when the subscriber ports-out his service to the first network, he sets call forwarding, at his original number given by the third network, to the first network's assigned new number. The subscriber will get a new SIM and a new IMSI from the first network. When a call is made to the subscriber's original number, the operator in the third network forwards the call to the new number. However, this technique is not feasible for forwarding SMS or carrying out other VAS.

An enhancing technique over the existing call forwarding approach configures an Home Location Register (HLR) in the port-out operator's network (i.e. third network) to replace a Visited Mobile Switching Center (VMSC) entry by an Short Message Service(SMS) forwarding gateway. Hence, any incoming message at the subscriber's third network number is forwarded to the SMS gateway. Thereafter, the SMS gateway relays the SMS to the new number given by first network. However, in such a case, any call or SMS initiated by the subscriber from the first network indicates his new number rather than the original number. Hence, this creates confusion for other subscribers receiving calls from the new number of the ported-out subscriber, as they are unaware of the subscriber's new number.

One or more of the above techniques are unable to provide the original number while the subscriber calls or uses a Value Added Service (VAS) from the first network. Hence, there is a need in the art for a cost effective solution to provide the Caller Line Identification (CLI) in MNP without the need of upgrading network elements.

### SUMMARY

The present invention is directed to providing a method and system for facilitating MNP. The method includes receiving a registration message at a Signaling Gateway (SG) for an International Mobile Subscriber Identity (IMSI) associated with a subscriber ported-in in a first network. The method further includes replacing at the SG, a first Mobile Station International Subscriber Directory Number (MSISDN) with an original MSISDN in a registration response message sent upon receipt of the registration message.

An aspect of the invention presents a system for facilitating MNP. The system includes a Signaling Gateway (SG) coupled to the first network. The SG receives a registration message for an International Mobile Subscriber Identity (IMSI) associated with a subscriber ported-in in the first network. Further, the SG replaces a first MSISDN with an original MSISDN in a registration response message, sent upon receipt of the registration message.

Another aspect of the present invention provides a computer program product including a computer usable program code for facilitating MNP by, receiving a registration message at a signaling gateway (SG) for an International Mobile Subscriber Identity (IMSI) associated with a subscriber ported-in in a first network, and replacing at the SG, a first MSISDN with an original MSISDN in a registration response message sent upon receipt of the registration message.

### BRIEF DESCRIPTION OF DRAWINGS

In the drawings, the same or similar reference numbers identify similar elements or acts.

FIG. 1 represents a system for facilitating MNP, in accordance with an embodiment of the invention;

FIG. 2 represents a flow diagram for registration of a subscriber (ported-in in a first network) with a second network, in accordance with an embodiment of the invention;

FIG. 3 represents a flow diagram of MT call to the subscriber at his original MSISDN, in accordance with an embodiment of the invention;

FIG. 4 represents a flow diagram of MT SMS to the subscriber at his original MSISDN, in accordance with an embodiment of the invention;

FIG. 5 represents a flow diagram of MO call from the subscriber using his original MSISDN, in accordance with an embodiment of the invention;

FIG. 6 represents a flow diagram of MO SMS from the subscriber using his original MSISDN, in accordance with an embodiment of the invention;

FIG. 7 represents a flow diagram for establishing a GPRS session for the subscriber, in accordance with an embodiment of the invention;

FIG. 8 represents a flow diagram of MO MMS from the subscriber using his original MSISDN, in accordance with an embodiment of the invention; and

FIG. 9 represents a flow diagram of MT MMS to the subscriber at his original MSISDN, in accordance with an embodiment of the invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practised without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the invention. The appearance of the phrase “in an embodiment”, in various places in the specification, does not necessarily refer to the same embodiment.

The present invention provides a system, method and a computer program product for facilitating MNP. The system facilitates mobile number portability for a subscriber ported-in to a first network and currently associated with a second network. From the perspective of the subscriber, the first network is an HPMN, while the second network is a VPMN. After receiving the ported-in subscriber, the first network assigns a new SIM with a first IMSI having a first MSISDN. Moreover, subscriber is ported-in in the first network, while he originally belonged to a third network (i.e., an original network) from where he already possessed an original MSISDN corresponding to the third network. Hereinafter, the third network is interchangeably referred to as the original network. From the perspective of the third network, the subscriber is ported-out, while the same subscriber is ported-in to the first network. The system facilitates caller line identification as the original MSISDN during subscriber's signaling exchange between the first, second and third network. In one embodiment of the invention, the first, second and original network represent different operators in the same country. In another embodiment of the invention, the first, second and original network represent different operators in different countries. The system provides a seamless implementation to allow a plurality of services, but not limited to, call related and non-call related (i.e. VAS) for all its subscribers.

CLI in MNP System

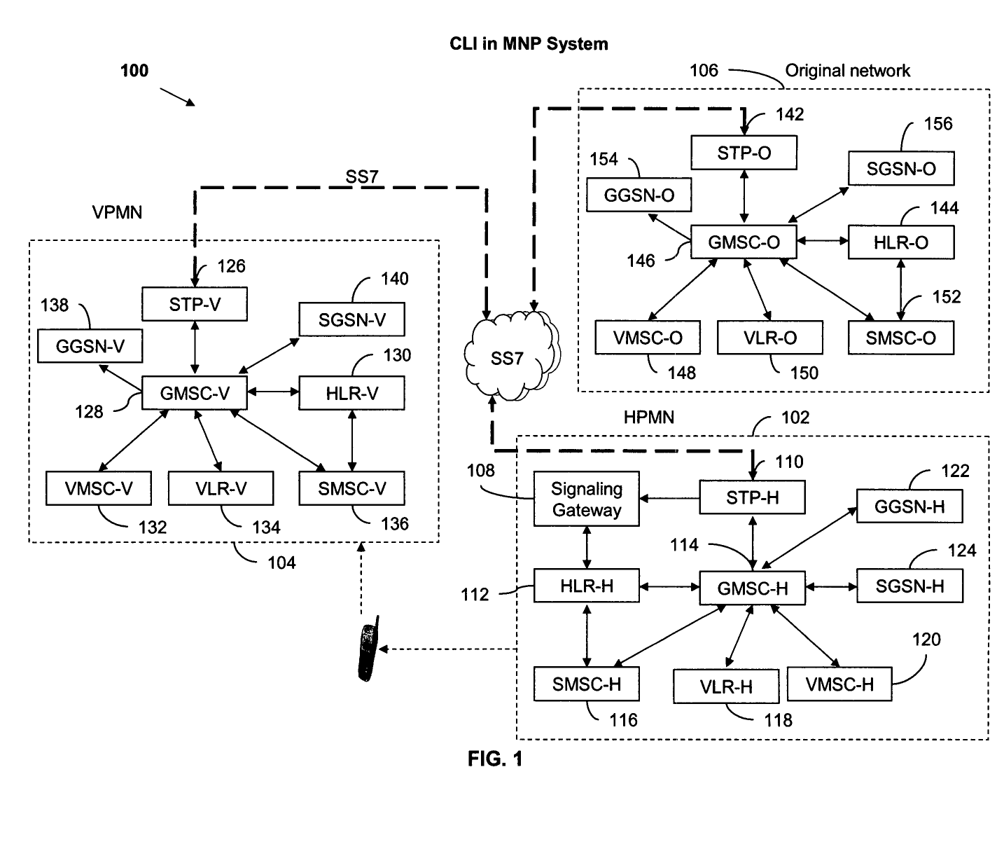

FIG. 1 represents a system 100 for facilitating MNP. The system includes an HPMN 102, a VPMN 104 and an original network 106. The subscriber ports his mobile number from original network 106 to HPMN 102, and is currently associated with VPMN 104. The HPMN 102, VPMN 104 and original network 106 exchange SS7 signaling. The HPMN 102 includes a Signaling Gateway (SG) 108 coupled to an STP-H 110. The HPMN 102 further includes an HLR-H 112, a GMSC-H 114, an SMSC-H 116, a VLR-H 118, a VMSC-H 120, a GGSN-H 122 and an SGSN-H 124, all interconnected and communicating via SS7 signaling. The VPMN 104 includes an STP-V 126, a GMSC-V 128, an HLR-V 130, a VMSC-V 132, a VLR-V 134, an SMSC-V 136, a GGSN-V 138, and an SGSN-V 140, all interconnected and communicating via SS7 signaling original network 106 also includes similar network elements such as an STP-O 142, an HLR-O 144, a GMSC-O 146, a VMSC-O 148, a VLR-O 150, an SMSC-O 152, a GGSN-O 154 and an SGSN-O 156. STP-H 110, STP-O 142 and STP-V 126 are the primary signaling exchange points in their respective networks. In other words, any signaling, exchanged with any other network component in the network, first passes through its corresponding STP. It would be apparent to a person skilled in the art that any network element in HPMN 102, VPMN 104 and original network 106 may communicate with any other element in another network via SS7 signaling. In addition, HPMN 102, VPMN 104, and original network 106 may include other network components that are standard, depending upon the architecture under consideration.

The HPMN 102 allocates a new SIM with a first IMSI when the subscriber is ported-in HPMN 102. In addition, the subscriber already possesses an original MSISDN, from his original network, but after porting in to HPMN 102, gets a new first MSISDN corresponding to the first IMSI. The first IMSI is from a special range of IMSIs and hence all SCCP signaling corresponding to this IMSI is routed through SG 108. The routing is achieved by configuring STP-H 110 for global title translation of the special range of IMSIs with DPC set as an address of SG 108. Hence, all signaling at STP-H 110 is directed to SG 108. Further, STP-H 110 routes all E164 signaling with CdPA as CC-NDC-Y through SG 108. The CdPA has a suffix to CC-NDC with Y for those networks, which do not have Y as a suffix. The networks with the suffix Y may be friendly partner networks of original network 106, where the subscriber has ported-out his number. Further, HPMN 102 maintains profile of the subscriber corresponding to HLR-H 112 instead of HLR-O 138. In other words, local profile of the subscriber is maintained at a network where he is ported-in (i.e. HPMN 102), rather than profile of a network from where he is ported-out (i.e. original network 106).

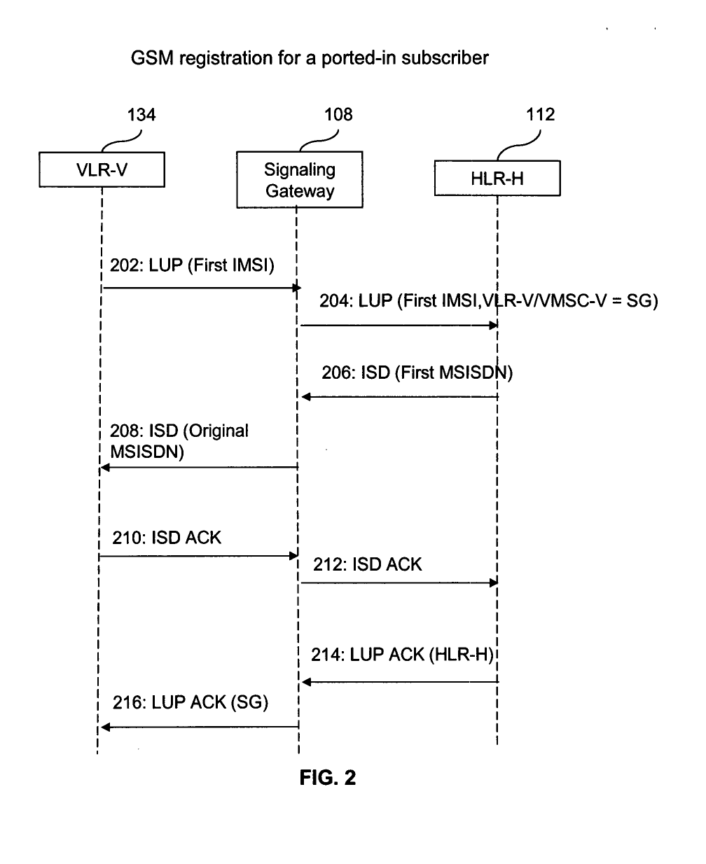

FIG. 2 represents a flow diagram for registration of a subscriber (ported-in to the first network) with the second network, in accordance with an embodiment of the invention. The subscriber is ported-in in HPMN 102 and attempts to register with VPMN 104. When the subscriber attempts to register with VPMN 104, then at step 202, VLR-V 130 issues a registration message with first IMSI corresponding to HPMN 102. In one embodiment of the invention, the registration message is a GSM Location Update (LUP) message. The registration message is destined to HLR-H 112. Since STP-H 110 is configured to route any signaling associated with the first IMSI to SG 108, the registration message is intercepted at SG 108. At step 204, SG 108 relays the registration message to HLR-H 112, after modification of location address of VLR-V 134 and VMSC-V 132 as address of SG 108. This enables receipt of any subsequent response from HLR-H 112 directly at SG 108, rather than at VLR-V 134 or VMSC-V 132. Thereafter, at step 206, HLR-H 112 sends a registration response message to SG 108. In one embodiment of the invention, the registration response message is an ISD message with first MSISDN. HLR-H 112 also sends other profile data such as, but not limited to, Supplementary Service(SS) information to SG 108.

Further, at step 208, SG 108 replaces first MSISDN with the original MSISDN in the ISD message and sends the modified ISD message to VLR-V 134 (or VMSC-V 132). The SG 108 maintains a mapping of association between original MSISDN and first MSISDN. At step 210, the VLR-V 134 sends an ISD ACK to SG 108. At step 212, SG 108 relays the ISD ACK to HLR-H 112. Thereafter, at step 214, HLR-H 112 sends LUP ACK with address of HLR-H 112 to SG 108. Finally, at step 216, SG 108 modifies the LUP ACK to replace the address of HLR-H 112 with address of SG 108, and relays the same to VLR-V 134. Hence, the first MSISDN is replaced with original MSISDN at VLR-V 134 when the subscriber registers with VPMN 104.

One embodiment of the invention describes a GPRS registration attempt by the subscriber in VPMN 104. The call flow described in conjunction with FIG. 1 remains the same, except the following changes: SGSN-V 140 replaces VLR-V 134 and sends a GPRS LUP at step 202, as a GPRS registration message. Thereafter, at step 204, SG 108 replaces address of SGSN-V 140 with the address of SG 108. Furthermore, at step 206, profile information sent along with ISD message contains a PDP context to SGSN-V 140. It will be apparent to a person skilled in the art that all the subsequent acknowledgement/response messages are GPRS related.

In another embodiment of the invention, SG 108 modifies its own address to include a roaming identifier when the subscriber is associated with VPMN 104, in order to signify the subscriber as a roaming subscriber to HLR-H 112. Also, SG 108 modifies its own address to include a non-roaming identifier when the subscriber is present in HPMN 102, in order to signify the subscriber as a non-roaming subscriber to HLR-H 112. It will be apparent to a person skilled in the art that roaming and non-roaming identifiers are necessary when one VPMN network is a friendly network of HPMN, while the other is not. This leads to modification in billing methodologies accordingly.

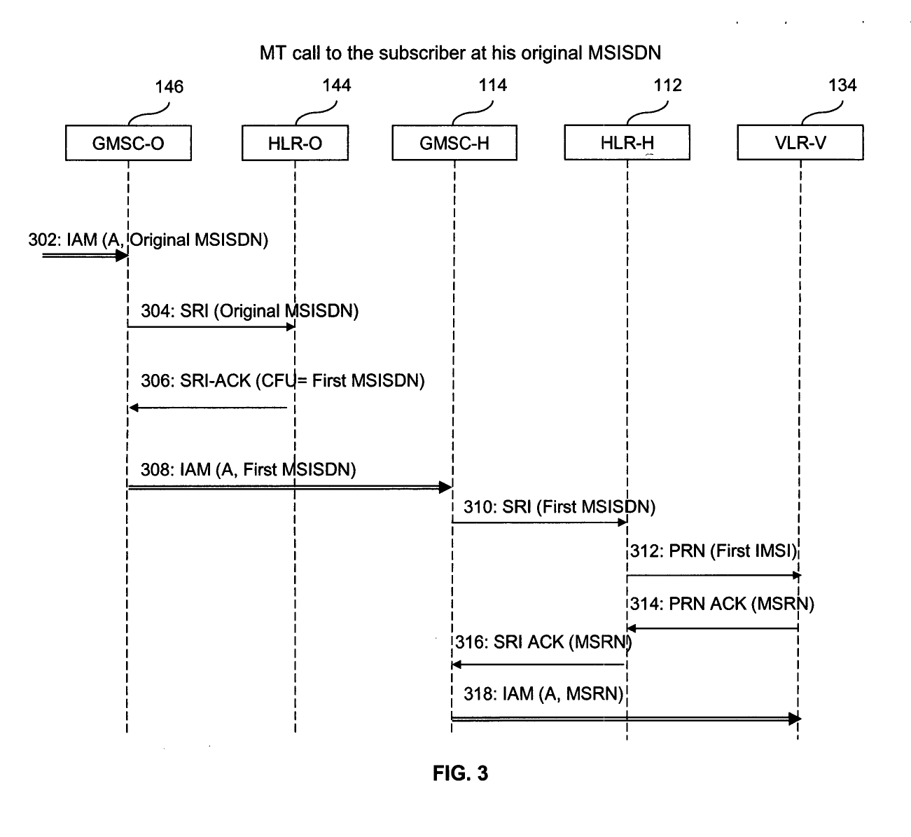

FIG. 3 represents a flow diagram of MT call to the subscriber at his original MSISDN, in accordance with an embodiment of the invention. A subscriber ‘A’ calls a subscriber ‘B’, when the subscriber B is ported-in in HPMN 102 from original network 106. Subscriber A calls subscriber B at his original MSISDN, corresponding to original network 106, since subscriber A is unaware of subscriber B's current location. At step 302, SMSC-O 152 receives an IAM (A, original MSISDN) when subscriber A calls subscriber B. At step 304, GMSC-O 146 sends a routing information query with original MSISDN to HLR-O 144. In one embodiment of the invention, the routing information query is an SRI query. Thereafter, at step 306, HLR-O 144 returns first MSISDN, which is set as a call forwarding number at HLR-O 144 for the original MSISDN. At step 308, GMSC-O 146 routes the call using IAM(A, first MSISDN) to GMSC-H 114.

Thereafter, at step 310, GMSC-H 114 issues a routing query (such as an SRI) with first MSISDN to HLR-H 112. At step 312, HLR-H 112 issues a roaming number request query, such as a PRN, for the first IMSI to VLR-V 134, since subscriber B is currently associated with VPMN 104. Thereafter, at step 314, VLR-V 134 sends MSRN as a PRN acknowledgment for subscriber B to HLR-H 112. At step 316, HLR-H 112 returns the MSRN to GMSC-H 114 as a response to the SRI sent at step 310. Finally, at step 318, GMSC-H 114 continues the call using IAM(A, MSRN) to VMSC 132. Hence, a call to subscriber B's original MSISDN is forwarded to its corresponding MSRN in VPMN 104.

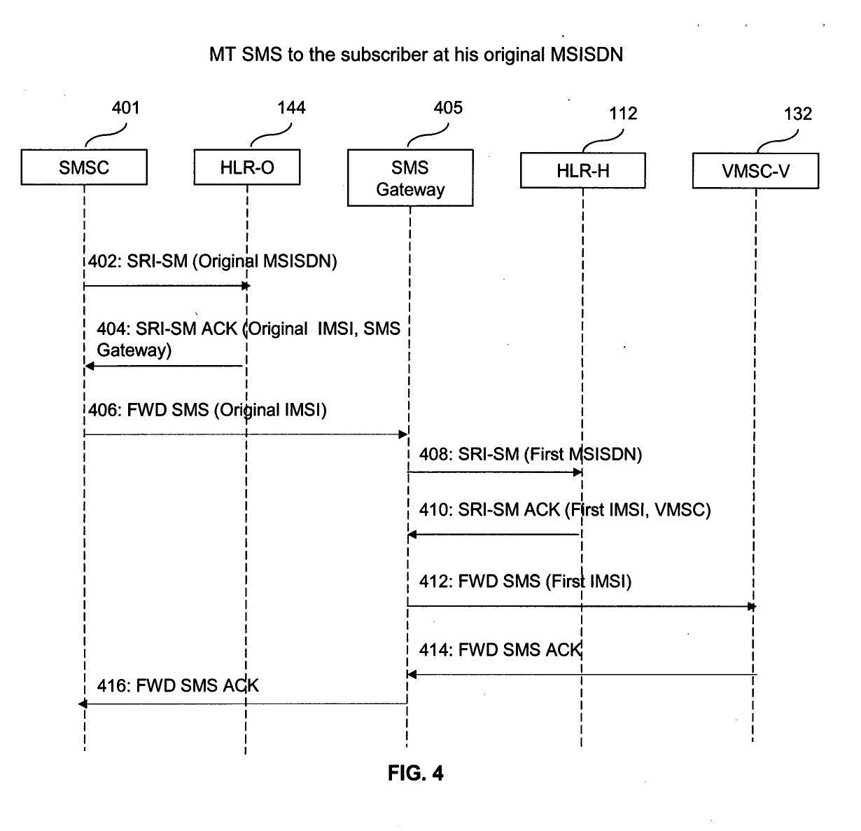

FIG. 4 represents a flow diagram of MT SMS to the subscriber at his original MSISDN, in accordance with an embodiment of the invention. Subscriber A sends an SMS to subscriber B at his original MSISDN when subscriber B is roaming in VPMN 104. An SMSC 401 stores the SMS intended for subscriber B. At step 402, SMSC 401 sends a routing information query (e.g. SRI-SM(original MSISDN)) to HLR-O 144. At step 404, HLR-O 144 returns an original IMSI corresponding to original network 106 and address of an SMS gateway 405. In one embodiment of the invention, SMS Gateway 405 is coupled to original network 106. Thereafter, at step 406, SMSC 401 forwards the SMS to SMS Gateway 405. SMS Gateway 405 queries a mobile number portability database coupled to it, to retrieve ported-out information of subscriber B. SMS gateway 405 receives first MSISDN and first IMSI, corresponding to the original MSISDN and the original IMSI, respectively. Thereafter, at step 408, SMS gateway 405 issues an SRI-SM (first MSISDN) to HLR-H 112.

At step 410, HLR-H 112 returns address of VMSC-V 132 and first IMSI to SMS gateway 405. Subscriber B is currently associated with VMSC-V 132. Thereafter, at step 412, SMS gateway 405 forwards the SMS on first IMSI to VMSC-V 132. Thereafter, at step 414, VMSC-V 132 sends an acknowledgment to the receipt of the forwarded SMS back to SMS gateway 405. Finally, at step 416, SMS gateway 405 relays the acknowledgement to SMSC 401, to indicate the successful delivery of SMS from originating SMSC 401 to VMSC-V 132.

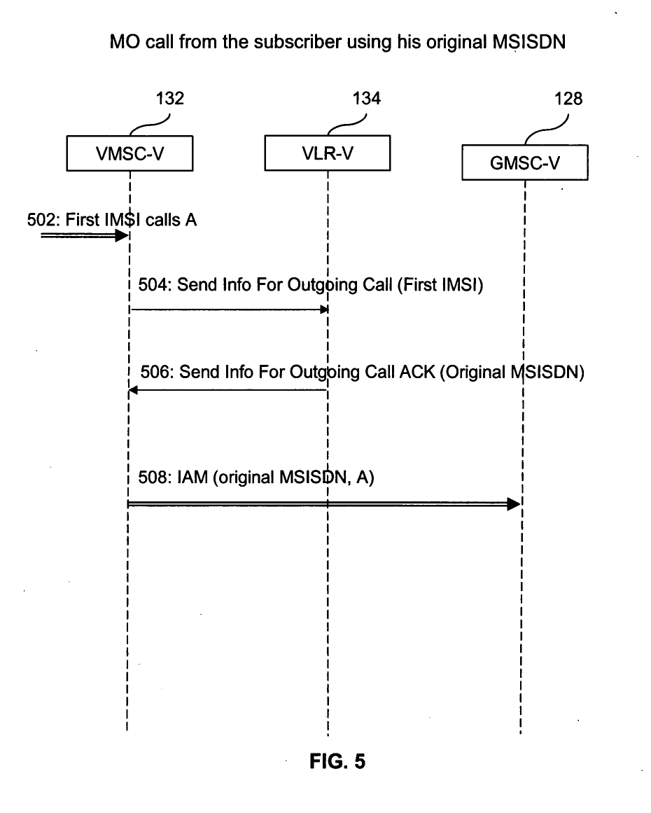

FIG. 5 represents a flow diagram of MO call from the subscriber using his original MSISDN, in accordance with an embodiment of the invention. In this embodiment, subscriber B calls subscriber A, when subscriber B is ported-in in HPMN 102 and is presently associated with VPMN 104. At step 502, subscriber B initiates a call to subscriber A with first IMSI and the call request lands at VMSC-V 132. At step 504, VMSC-V 132 queries VLR-V 134 for subscriber B's profile information for outgoing calls. Since subscriber B is already registered with VPMN 104, VLR-V 134 possesses the original MSISDN of subscriber B instead of first MSISDN as explained in conjunction with FIG. 1. Hence, at step 506, VLR-V 134 sends an acknowledgement to VMSC-V 132 with subscriber B's original MSISDN. Thereafter, at step 508, VMSC-V 132 sends a call request, such as IAM(original MSISDN, A) to GMSC-V 128. Finally, GMSC-V 128 routes the call to subscriber A using standard routing procedures. Hence, subscriber B is able to call any other subscriber using his original MSISDN even when he is ported-out to HPMN 102 and has the corresponding first MSISDN. A similar call flow is used for MO SMS by subscriber B.

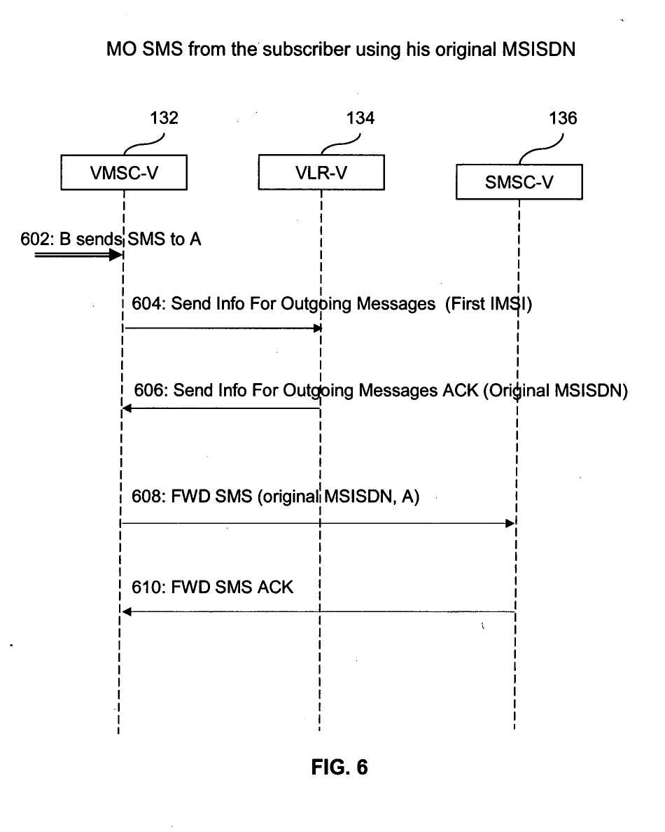

FIG. 6 represents a flow diagram of MO SMS from the subscriber using his original MSISDN, in accordance with an embodiment of the invention. At step 602, subscriber B's request for sending SMS to subscriber A lands at VMSC-V 132. At step 604, VMSC-V 132 queries VLR-V 134 for subscriber B's profile information for outgoing messages. Since subscriber B is already registered with VPMN 104, VLR-V 134 possesses the original MSISDN of subscriber B instead of first MSISDN. Hence, at step 606, VLR-V 134 sends an acknowledgement for the profile information request to VMSC-V 132 with original MSISDN. Thereafter, at step 608, VMSC-V 132 forwards the SMS to SMSC-V 136 with original MSISDN. Finally, at step 610, SMSC-V 136 acknowledges receipt of the forwarded SMS request to VMSC-V 132. Further, SMSC-V 136 routes the SMS intended for subscriber A using standard routing procedures. It will be apparent to a person skilled in the art that call flows with similar logic can be extended to implement various value added services for subscriber B.

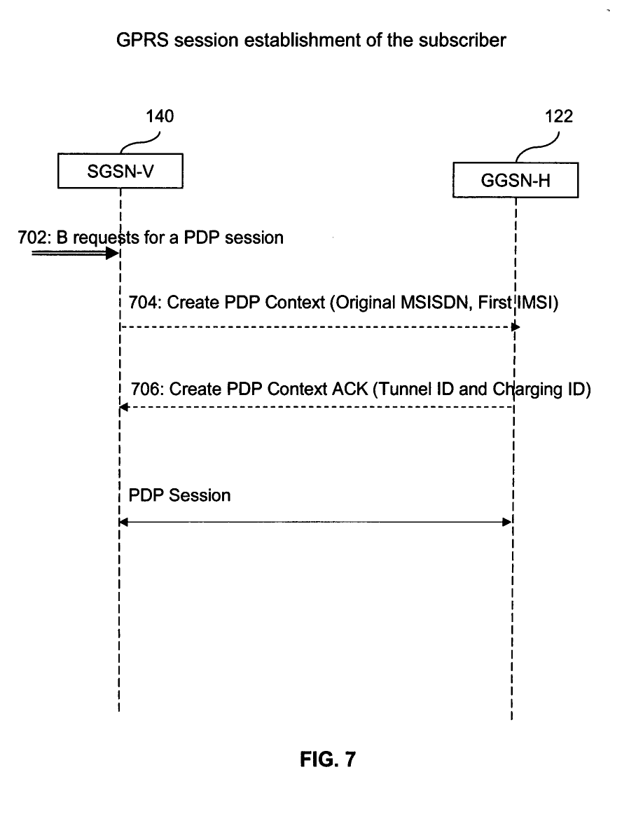

FIG. 7 represents a flow diagram for establishing a GPRS session for the subscriber ported-in in HPMN 102, in accordance with an embodiment of the invention. Subscriber B, present in VPMN 104, is already registered for GPRS service, as explained in conjunction with FIG. 1. At step 702, subscriber B, using his handset requests for a GPRS PDP on HPMN's Access Point Network (APN) and the request reaches SGSN-V 140. SGSN-V 140 uses Domain Name System (DNS) to resolve the APN to locate GGSN-H 122. Thereafter, at step 704, SGSN-V 140 sends a Create PDP context message to GGSN-H 122 with first IMSI and HPMN's APN and original MSISDN. Furthermore, at step 706, GGSN-H 122 acknowledges the request and sends a tunnel ID and charging ID back to SGSN-V 140. Also, GGSN-H 122 maintains a record of all information like first IMSI, HPMN's APN and original MSISDN for subscriber B. Thereafter, subscriber B starts the PDP session.

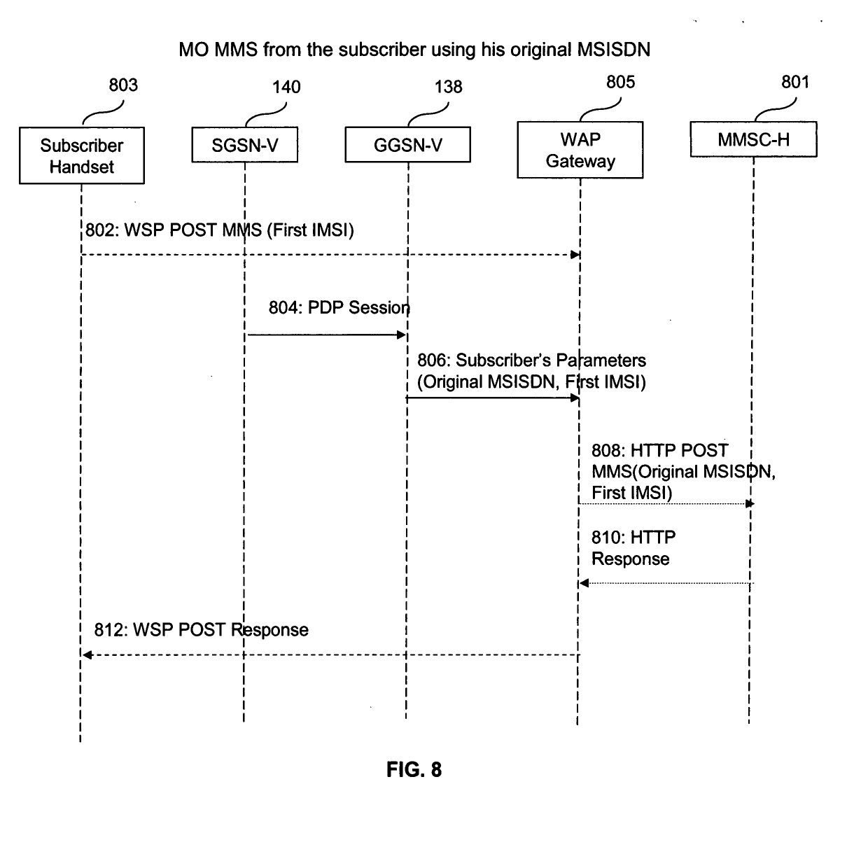

FIG. 8 represents a flow diagram of MO MMS from the subscriber using his original MSISDN, in accordance with an embodiment of the invention. In order to implement MMS services, this embodiment represents additional network elements in HPMN 102, such as an MMSC-H 801. At step 802, subscriber B, using his handset 803, sends a Wireless Session Protocol (WSP) POST message to send the MMS using the first IMSI to MMSC-H 801. The WSP POST request is routed through SGSN-V 140, which creates a PDP session with GGSN-V 138, at step 804. Since the subscriber has already registered for GPRS services when registering with VPMN 104, SGSN-V 140 maintains the mapping information of the first MSISDN and the original MSISDN for subscriber B. Hence, at step 806, GGSN-V 138 sends the original MSISDN and first IMSI information to a WAP gateway 805. At step 808, WAP gateway 805 converts WSP POST request into an HTTP POST request with subscriber B's parameters, such as original MSISDN and first IMSI, and sends the modified request to MMSC-H 801. Thereafter, at step 810, MMSC-H 801 sends an HTTP response to WAP gateway 805. Furthermore, at step 812, WAP gateway 805 sends a WSP POST response to subscriber B's handset 803, as a response to the request sent at step 802. MMSC-H 801 further routes the message to the intended recipient using standard MMS routing procedures.

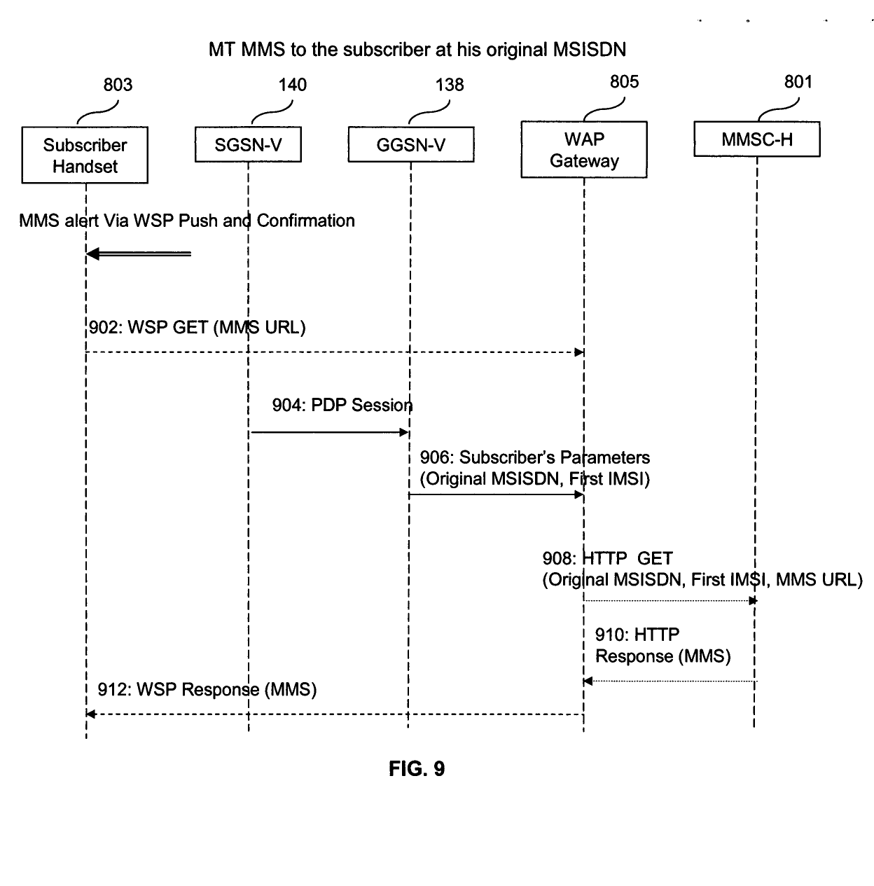

FIG. 9 represents a flow diagram of MT MMS to the subscriber at his original MSISDN, in accordance with an embodiment of the invention. Subscriber B receives an MMS alert via a WSP confirmed push at his handset 803. At step 902, subscriber B, using his handset 803 establishes a WSP GET session with MMS URL towards the WAP gateway 805. The WSP GET session is routed through SGSN-V 140, which creates a PDP session with GGSN-V 138, at step 904. SGSN-V 140 already possesses the mapping information of the first MSISDN and the original MSISDN for subscriber B. Hence, at step 906, GGSN-V 138 sends the original MSISDN and first IMSI information to WAP gateway 805. At step 908, WAP gateway 805 converts WSP GET request into an HTTP GET request with subscriber B's parameters, such as, original MSISDN, first IMSI and MMS URL. Thereafter, WAP gateway 805 sends the same to MMSC-H 801. Thereafter, at step 910, MMSC-H 801 sends an HTTP response with the MMS to WAP gateway 805. Further, at step 912, WAP gateway 805 sends the MMS message as WSP response to subscriber B's handset 803, as a response to the WSP GET request sent at step 902.

The present invention can take the form of an entirely hardware embodiment, an entirely software embodiment or an embodiment containing both hardware and software elements. In accordance with an embodiment of the present invention, software including but is not limited to firmware, resident software, and microcode, implements the invention.

Furthermore, the invention can take the form of a computer program product, accessible from a computer-usable or computer-readable medium providing program code for use, by or in connection with, a computer or any instruction execution system. For the purposes of this description, a computer-usable or computer readable medium can be any apparatus that can contain, store, communicate, propagate, or transport the program, for use by, or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

An HPMN operator uses the CLI in MNP system to serve subscribers associated with its network even when they are not in the coverage of home network, and are ported-in from a third network. The CLI in MNP system facilitates its subscribers to provide call related and value added services. The subscriber is able to receive calls at his original number even when he has ported out his number to HPMN and may be roaming in VPMN. Further, the subscriber is able to indicate his original MSISDN in CLI when initiating any call or a VAS from the VPMN. This prevents any confusion to the recipient, as the recipient may not be aware of the new ported-out number of the subscriber. Moreover, the CLI in MNP system also facilitates the subscriber to receive any call or VAS message at his original number, by forwarding the same to his new number.

The components of CLI in MNP system described above include any combination of computing components and devices operating together. The components of the CLI in MNP system can also be components or subsystems within a larger computer system or network. The CLI in MNP system components can also be coupled with any number of other components (not shown), for example, other buses, controllers, memory devices, and data input/output devices, in any number of combinations. In addition, any number or combination of other processor based components may be carrying out the functions of the CLI in MNP system.

It should be noted that the various components disclosed herein may be described using computer aided design tools and/or expressed (or represented), as data, and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media, or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the CLI in MNP system is not intended to be exhaustive, or to limit the CLI in MNP system to the precise form disclosed. While specific embodiments of, and examples for, the CLI in MNP system are described herein for illustrative purposes, various equivalent modifications are possible within the scope of the CLI in MNP system, as those skilled in the art will recognize. The teachings of the CLI in MNP system provided herein can be applied to other processing systems and methods. They may not be limited to the systems and methods described above.

The elements and acts of the various embodiments described above can be combined to provide further embodiments. These and other changes can be made in light of the above-mentioned detailed description.

Other Variations

In describing certain embodiments of the CLI in MNP system under the present invention, this specification follows the path of a telecommunications call, from a calling party to a called party. For the avoidance of doubt, that call can be for a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

APPENDIX

| Acronym | Description |
|---|---|
| 3G | Third generation of mobile |
| BSC | Base Station Controller |
| BCSM | Basic Call State Model |
| CAMEL | Customized Application for Mobile Enhanced Logic |
| CDMA | Code Division Multiplexed Access |
| CLI | Calling Line Identification |
| CgPA | Calling Party Address |
| CdPA | Called Party Address |
| CAP | Camel Application Part |
| CC | Country Code |
| CB | Call Barring |
| CSI | Camel Subscription Information |
| DPC | Destination Point Code |
| DNS | Domain Name System |
| GGSN | Gateway GPRS Support Node |
| GMSC | Gateway MSC |
| GPRS | General Packet Radio System |
| GLR | Gateway Location Register |
| GSM | Global System for Mobile |
| GSM SSF | GSM Service Switching Function |
| GT | Global Title |
| HLR -V | HLR from VPMN |
| HLR -O | HLR from Originating network |
| HLR -H | HLR from HPMN |
| HLR | Home Location Register |
| HPMN | Home Public Mobile Network |
| IMSI | International Mobile Subscriber Identity |
| ICV | Integrated Cellular VoIP |
| IN | Intelligent Network |
| ISG | International Signal Gateway |
| INAP | Intelligent Network Application Part |
| ISD | MAP Insert Subscriber Data |
| IAM | Initial Address Message |
| IDP | Initial DP IN/CAP message |
| ITR | Inbound Traffic Redirection |
| ISUP | ISDN User Part |
| LU | Location Update |
| LUP | MAP Location Update |
| MAP | Mobile Application Part |
| MCC | Mobile Country Code |
| MCC | Mobile Country Code |
| ME | Mobile Equipment |
| MNC | Mobile Network Code |
| MO | Mobile Originated |
| MMSC | Multimedia Message Switching Center |
| MSC | Mobile Switching Center |
| MSISDN | Mobile Subscriber ISDN Number |
| MSRN | Mobile Subscriber Roaming Number |
| MT | Mobile Terminated |
| MTP | Message Transfer Part |
| NP | Numbering Plan |
| NPI | Numbering Plan Indicator |
| NDC | National Dialing Code |
| ODB | Operator Determined Barring |
| OTA | Over The Air |
| O-CSI | Originating CAMEL Subscription Information |
| PRN | Provide Roaming Number |
| RNA | Roaming Not Allowed |
| RPD | Roamer Probe Database |
| RR | Roaming Restricted due to unsupported feature |
| RI | Routing Indicator |
| SPC | Signal Point Code |
| SRI | Send Routing Information |
| SGSN | Serving GPRS Support Node |
| SCCP | Signal Connection Control part |
| STP | Signal Transfer Point |
| STP-H | HPMN STP |
| STP-V | VPMN STP |
| STP-O | Originating Network STP |
| SRI-SM | Send Routing Information For Short Message |
| SSP | Service Switch Point |
| SSN | Sub System Number |
| SIM | Subscriber Identify Module |
| STK | SIM Tool Kit Application |
| SM-RP-UI | Short Message Relay Protocol User Information |
| STP | Signal Transfer Point |
| SS | Supplementary Services |
| TR | Traffic Redirection |
| T-CSI | Terminating CAMEL Service Information |
| TCAP | Transaction Capabilities Application Part |
| TP | SMS Transport Protocol |
| UDHI | User Data Header Indicator |
| UDH | User Data Header |
| UD | User Data |
| VAS | Value Added Service |
| VLR - H | VLR from HPMN |
| VLR - O | VLR from Originating network |
| VLR - V | VLR from VPMN |
| VoIP | Voice over Internet Protocol |
| VLR | Visited Location Register |
| VMSC | Visited Mobile Switching Center |
| WSP | Wireless Session Protocol |

Technical references (each of which is incorporated by reference in its entirety)
GSM 902 on MAP specification Digital cellular telecommunications system (Phase 2+) Mobile Application Part (MAP) Specification (3GPP TS 09.02 version 7.9.0 Release 1998)
GSM 348 Security and OTA, GSM 902 on MAP specification Digital cellular telecommunications system (Phase 2+); Mobile Application Part (MAP) Specification (3GPP TS 09.02 version 7.9.0 Release 1998)
GSM 340 on SMS Digital cellular telecommunications system (Phase 2+); Technical realization of the Short Message Service (SMS); (GSM 03.40 version 7.4.0 Release 1998)
GSM 378 on CAMEL Digital cellular telecommunications system (Phase 2+); Customized Applications for Mobile network Enhanced Logic (CAMEL) Phase 2; Stage 2 (GSM 03.78 version 6.7.0 Release 1997)
GSM 978 on CAMEL Application protocol Digital cellular telecommunications system (Phase 2+); Customized Applications for Mobile network Enhanced Logic (CAMEL); CAMEL Application Part (CAP) specification (GSM 09.78 version 7.1.0 Release 1998) Signalling procedures and the Mobile Application Part (MAP) (Release 1999)
Q1214-Q1218 on Intelligent Networks
Q701-704 on SS7 MTP
Q711-Q714 on SS7 SCCP
Q760-Q769 on SS7 ISUP

1. A method for facilitating mobile number portability, the method comprising:
receiving a registration message at a signaling gateway (SG) for an International Mobile Subscriber Identity (IMSI) associated with a subscriber, the subscriber being ported-in in a first network and having an original Mobile Station International Subscriber Directory Number (MSISDN) associated with an original network;
assigning a first (MSISDN) associated with the first network to the subscriber;
replacing the first MSISDN with the original MSISDN; and
sending, in response to the registration message, a registration response message containing the original MSISDN.

2. The method of claim 1, wherein the IMSI corresponds to a Subscriber Identity Module (SIM) allocated to the subscriber in the first network.

3. The method of claim 1, wherein the subscriber is ported-out of the original network to the first network.

4. The method of claim 1, wherein the registration message is selected from a group consisting of a Location Update (LUP) message and a General Packet Radio Service (GPRS) LUP message.

5. The method of claim 1, wherein the registration response message is an Insert Subscriber Data (ISD) message.

6. The method of claim 1, wherein the subscriber is attempting to register with a second network, the method further comprising: redirecting the registration message received from the second network to the SG.

7. The method of claim 6, wherein redirecting the registration message further comprises: receiving signaling from the subscriber, the signaling indicating a destination address; and replacing, at a Signaling Transfer Point (STP) in the first network, the destination address with an address of the SG.

8. The method of claim 1, wherein the subscriber is associated with a second network.

9. The method of claim 8, wherein the SG has an address, further comprising:
modifying, at the SG, one or more location addresses in the registration message received from the second network with the address of the SG.

10. The method of claim 9, further comprising:
relaying the registration message via the SG to a first Home Location Register (HLR) in the first network.

11. The method of claim 1, wherein the first MSISDN is assigned at a first HLR in the first network.

12. The method of claim 11, further comprising:
at the SG, maintaining a profile for the subscriber, the profile corresponding to the first HLR.

13. The method of claim 1, further comprising:
transferring, at the SG, the registration response message with the original MSISDN to a second network.

14. The method of claim 13, wherein the registration response message is transferred to one selected from a group consisting of a VLR, a VMSC and a SGSN, each of which is associated with the second network.

15. The method of claim 1, further comprising:
at the SG, maintaining a mapping between the first MSISDN and the original MSISDN.

16. The method of claim 1, wherein the SG has an address, the method further comprising:
including a roaming identifier in the address of the SG, the roaming identifier being useable for exchanging signaling between the SG and the first network, while the subscriber is roaming in a second network.

17. The method of claim 1, wherein the SG has an address, the method further comprising:
including a non-roaming identifier in the address of the SG, the non-roaming identifier being useable for exchanging signaling between the SG and the first network, while the subscriber is present in the first network.

18. A system for facilitating mobile number portability, the system comprising:
means for receiving a registration message at a signaling gateway (SG) for an International Mobile Subscriber Identity (IMSI) associated with a subscriber, the subscriber being ported-in in a first network and having an original Mobile Station International Subscriber Directory Number (MSISDN) associated with an original network;
means for assigning a first (MSISDN) associated with the first network to the subscriber;
means for replacing the first MSISDN with the original MSISDN; and
means for sending, in response to the registration message, a registration response message containing the original MSISDN.

19. The system of claim 18, wherein the IMSI corresponds to a Subscriber Identity Module (SIM) allocated to the subscriber in the first network.

20. The system of claim 18, wherein the subscriber is ported-out of the original network to the first network.

21. The system of claim 18, wherein the registration message is selected from a group consisting of a Location Update (LUP) message and a General Packet Radio Service (GPRS) LUP message.

22. The system of claim 18, wherein the registration response message is an Insert Subscriber Data (ISD) message.

23. The system of claim 18, wherein the subscriber is attempting to register with a second network, the system further comprising:
means for redirecting the registration message received from the second network to the SG.

24. The system of claim 18, wherein the subscriber is associated with a second network.

25. The system of claim 18, wherein the first MSISDN is assigned at a first HLR in the first network.

26. The system of claim 18, further comprising:
means for transferring, at the SG, the registration response message with the original MSISDN to a second network.

27. The system of claim 18, wherein the SG has an address, the system further comprising:
means for including a roaming identifier in the address of the SG, the roaming identifier being useable for exchanging signaling between the SG and the first network, while the subscriber is roaming in a second network.

28. The system of claim 18, wherein the SG has an address, the system further comprising:
means for including a non-roaming identifier in the address of the SG, the non-roaming identifier being useable for exchanging signaling between the SG and the first network, while the subscriber is present in the first network.

29. A computer program product comprising a computer usable medium having control logic stored therein for causing a computer to perform mobile communications, the control logic comprising computer readable program code means for:
receiving a registration message at a signaling gateway (SG) for an International Mobile Subscriber Identity (IMSI) associated with a subscriber, the subscriber being ported-in in a first network and having an original Mobile Station International Subscriber Directory Number (MSISDN) associated with an original network;
assigning a first (MSISDN) associated with the first network to the subscriber;
replacing the first MSISDN with the original MSISDN; and
sending, in response to the registration message, a registration response message containing the original MSISDN.

30. The computer program product of claim 29, wherein the IMSI corresponds to a Subscriber Identity Module (SIM) allocated to the subscriber in the first network.

31. The computer program product of claim 29, wherein the subscriber is ported-out of the original network to the first network.

32. The computer program product of claim 29, wherein the registration message is selected from a group consisting of a Location Update (LUP) message and a General Packet Radio Service (GPRS) LUP message.

33. The computer program product of claim 29, wherein the registration response message is an Insert Subscriber Data (ISD) message.

34. The computer program product of claim 29, wherein the subscriber is attempting to register with a second network, the control logic further comprising computer readable program code means for: redirecting the registration message received from the second network to the SG.

35. The computer program product of claim 29, wherein the subscriber is associated with a second network.

36. The computer program product of claim 29, wherein the first MSISDN is assigned at a first HLR in the first network.

37. The computer program product of claim 29, the control logic further comprising computer readable program code means for:
transferring, at the SG, the registration response message with the original MSISDN to a second network.

38. The computer program product of claim 37, wherein the registration response message is transferred to one selected from a group consisting of a VLR, a VMSC and a SGSN, each of which is associated with the second network.

39. The computer program product of claim 29, the control logic further comprising computer readable program code means for:
at the SG, maintaining a mapping between the first MSISDN and the original MSISDN.

40. The computer program product of claim 29, wherein the SG has an address, the control logic further comprising computer readable program code means for:
including a roaming identifier in the address of the SG, the roaming identifier being useable for exchanging signaling between the SG and the first network, while the subscriber is roaming in a second network.

41. The computer program product of claim 29, wherein the SG has an address, the control logic further comprising computer readable program code means for:
including a non-roaming identifier in the address of the SG, the non-roaming identifier being useable for exchanging signaling between the SG and the first network, while the subscriber is present in the first network.
